(19) United States
(12) Patent Application Publication
(10) Pub. No.: US 2026/0132278 A1
(43) Pub. Date: May 14, 2026

(54) GRIP RUBBER COMPOSITION AND GOLF CLUB GRIP

(71) Applicant: Sumitomo Rubber Industries, Ltd., Kobe-shi (JP)

(72) Inventors: Sho GOJI, Kobe-shi (JP); Takehiko HYODO, Kobe-shi (JP)

(73) Assignee: Sumitomo Rubber Industries, Ltd., Kobe-shi (JP)

(21) Appl. No.: 19/367,649

(22) Filed: Oct. 23, 2025

(30) Foreign Application Priority Data
Nov. 11, 2024 (JP) 2024-196757

(51) Int. Cl. C08L 15/00; A63B 53/14; A63B 60/14

(52) U.S. Cl. CPC C08L 15/005; A63B 53/14; A63B 60/14; C08L 2205/025; C08L 2205/03; C08L 2207/324

(57) ABSTRACT

An object of the present disclosure is to provide a grip rubber composition from which a crosslinked rubber having a great frictional coefficient can be obtained. The present disclosure provides a grip rubber composition containing a base rubber and a vulcanizing agent, wherein the base rubber contains a solid rubber that is a solid at a temperature of 25° C. and a liquid rubber that is a liquid at a temperature of 25° C., and a ratio (tan δ/E*) of a loss tangent (tan δ) to a complex elastic modulus (E*) (MPa) of a cured product of the grip rubber composition at a temperature of 25° C. ranges from 0.030 to 0.045, wherein the loss tangent (tan δ) and the complex elastic modulus (E*) (MPa) are measured with a dynamic viscoelastic spectrometer under measuring conditions of an oscillation frequency: 10 Hz, a strain amplitude: 0.05% and a tensile mode.

### FIELD OF THE PRESENT DISCLOSURE

The present disclosure relates to a grip rubber composition for use in production of a grip.

### DESCRIPTION OF THE RELATED ART

As a grip (anti-slip member) provided on sporting goods or the like, a grip made of a rubber is widely utilized. It has been proposed to use a hydrogenated carboxyl-modified acrylonitrile-butadiene rubber as a base rubber for such a grip.

For example, JP 2017-113388 A discloses a grip for sporting goods comprising an outermost surface layer formed from a surface layer rubber composition, wherein the surface layer rubber composition contains (A) a base rubber and (B) a resin having a softening point in a range from 5° C. to 120° C., (A) the base rubber contains an acrylonitrile-butadiene based rubber, and (B) the resin is at least one member selected from the group consisting of a hydrogenated rosin ester, a disproportionated rosin ester, an ethylene-vinyl acetate copolymer, a coumarone resin, a phenol resin, a xylene resin and a styrene resin.

### SUMMARY OF THE DISCLOSURE

The grip provided on sporting goods or the like is required to have excellent anti-slipping performance. The anti-slipping performance of the grip can be also improved by forming a groove pattern on the surface. However, it is preferable that the crosslinked rubber itself constituting the grip has a great frictional coefficient.

Herein, as a method for increasing the frictional coefficient of the crosslinked rubber, there is a method of adding a low molecular weight tackifying component such as a rosin resin and a coumarone resin, or a liquid softening agent in the rubber composition, as disclosed in JP 2017-113388 A. However, an excessive amount of the low molecular weight tackifying component or softening agent tends to cause a bleed phenomenon after curing.

The present disclosure has been made in view of the above circumstances, and an object of the present disclosure is to provide a grip rubber composition for a crosslinked rubber having a great frictional coefficient.

The present disclosure that has solved the above problem provides a grip rubber composition containing a base rubber and a vulcanizing agent, wherein the base rubber contains a solid rubber that is a solid at a temperature of 25° C. and a liquid rubber that is a liquid at a temperature of 25° C., and a ratio (tan δ/E*) of a loss tangent (tan δ) to a complex elastic modulus (E*) (MPa) of a cured product of the grip rubber composition at a temperature of 25° C. ranges from 0.030 to 0.045, wherein the loss tangent (tan δ) and the complex elastic modulus (E*) (MPa) are measured with a dynamic viscoelastic spectrometer under measuring conditions of an oscillation frequency: 10 Hz, a strain amplitude: 0.05% and a tensile mode.

If the solid rubber and the liquid rubber are used in combination as the base rubber, the obtained cured product (crosslinked rubber) has a great hysteresis loss during the deformation, and thus has a great frictional coefficient. In addition, the liquid rubber crosslinks with the solid rubber when the rubber composition is cured, and thus does not cause a bleed phenomenon after curing.

A crosslinked rubber having a great frictional coefficient is obtained from the grip rubber composition according to the present disclosure. Thus, according to the present disclosure, a grip composed of a crosslinked rubber that itself has a great frictional coefficient is obtained.

### BRIEF DESCRIPTION OF THE DRAWINGS

FIG. 1 is a perspective view showing one example of a golf club grip according to the present disclosure; and

FIG. 2 is a perspective view showing one example of a golf club provided with the golf club grip according to the present disclosure.

### DESCRIPTION OF THE PREFERRED EMBODIMENT

### [Rubber Composition]

The grip rubber composition according to the present disclosure (hereinafter, sometimes simply referred to as “rubber composition”) is used to mold a grip.

The rubber composition contains a base rubber and a vulcanizing agent, and the base rubber contains a solid rubber that is a solid at a temperature of 25° C. and a liquid rubber that is a liquid at a temperature of 25° C.

In addition, a ratio (tan δ/E*) of a loss tangent (tan δ) to a complex elastic modulus (E*) (MPa) of a cured product of the grip rubber composition at a temperature of 25° C. ranges from 0.030 to 0.045, wherein the loss tangent (tan δ) and the complex elastic modulus (E*) (MPa) are measured with a dynamic viscoelastic spectrometer under measuring conditions of an oscillation frequency: 10 Hz, a strain amplitude: 0.05% and a tensile mode.

If the solid rubber and the liquid rubber are used in combination as the base rubber, the obtained cured product (crosslinked rubber) has a great hysteresis loss during the deformation, and thus has a great frictional coefficient. In addition, the liquid rubber crosslinks with the solid rubber when the rubber composition is cured, and thus does not cause a bleed phenomenon after curing.

If the crosslinked rubber has a greater loss tangent (tan δ) at a temperature of 25° C., the crosslinked rubber has a greater energy loss during the deformation, and thus has a greater hysteresis friction. In addition, a greater complex elastic modulus (E*) (MPa) of the crosslinked rubber at a temperature of 25° C. (a hard crosslinked rubber) is disadvantageous to friction. Thus, it is considered that if their ratio (tan δ/E*) is 0.030 or more, the hysteresis loss is great and thus the crosslinked rubber has an improved frictional coefficient, and if their ratio (tan δ/E*) is 0.045 or less, occurrence of poor dispersion is prevented and thus the crosslinked rubber has an improved frictional coefficient.

### (Base Rubber)

The rubber composition contains a base rubber. The amount of the base rubber in the rubber composition is preferably 50 mass % or more, more preferably 55 mass % or more.

The base rubber contains a solid rubber that is a solid at a temperature of 25° C. and a liquid rubber that is a liquid at a temperature of 25° C.

### (Solid Rubber)

Examples of the solid rubber include a diene rubber such as a natural rubber (NR), an ethylene-propylene-diene rubber (EPDM), an acrylonitrile-butadiene rubber (NBR), a hydrogenated acrylonitrile-butadiene rubber (HNBR), a carboxyl-modified acrylonitrile-butadiene rubber (XNBR), a hydrogenated carboxyl-modified acrylonitrile-butadiene rubber (HXNBR), a butadiene rubber (BR), a styrene-butadiene rubber (SBR), an isoprene rubber (IR), and a chloroprene rubber (CR); and a non-diene rubber such as a butyl rubber (IIR), an ethylene-propylene rubber (EPM), and a urethane rubber (PU). These solid rubbers may be used solely, or two or more of them may be used in combination.

The solid rubber is preferably the diene rubber, more preferably the acrylonitrile-butadiene based rubber. The solid rubber even more preferably contains at least one member selected from the group consisting of the carboxyl-modified acrylonitrile-butadiene rubber (XNBR), the hydrogenated acrylonitrile-butadiene rubber (HNBR) and the hydrogenated carboxyl-modified acrylonitrile-butadiene rubber (HXNBR). The XNBR is a copolymer of a monomer having a carboxyl group, acrylonitrile and butadiene. The HNBR is a hydrogenated product of the acrylonitrile-butadiene rubber. The HXNBR is a hydrogenated product of the copolymer of the monomer having the carboxyl group, acrylonitrile and butadiene.

The amount of the acrylonitrile-butadiene based rubber in the solid rubber is preferably 50 mass % or more, more preferably 70 mass % or more, and even more preferably 90 mass % or more. In addition, it is also preferable that the solid rubber of the base rubber consists of the acrylonitrile-butadiene based rubber.

The amount of acrylonitrile in the NBR, XNBR, HNBR and HXNBR is preferably 15 mass % or more, more preferably 18 mass % or more, and even more preferably 21 mass % or more, and is preferably 50 mass % or less, more preferably 45 mass % or less, and even more preferably 40 mass % or less. If the amount of acrylonitrile is 15 mass % or more, the abrasion resistance is better, and if the amount of acrylonitrile is 50 mass % or less, the grip has a better touch feeling in a cold region or in winter.

The amount of the double bond in the HNBR and HXNBR is preferably 0.09 mmol/g or more, more preferably 0.2 mmol/g or more, and is preferably 2.5 mmol/g or less, more preferably 2.0 mmol/g or less, and even more preferably 1.5 mmol/g or less. If the amount of the double bond is 0.09 mmol/g or more, vulcanization is easily carried out during molding and the grip has enhanced tensile strength, and if the amount of the double bond is 2.5 mmol/g or less, the grip has better durability (weather resistance) and tensile strength. The amount of the double bond can be adjusted by the amount of butadiene in the copolymer or the amount of hydrogen added into the copolymer.

The monomer having the carboxyl group in the XNBR and HXNBR include acrylic acid, methacrylic acid, fumaric acid, and maleic acid. The amount of the monomer having the carboxyl group in the XNBR and HXNBR is preferably 1.0 mass % or more, more preferably 2.0 mass % or more, and even more preferably 3.5 mass % or more, and is preferably 30 mass % or less, more preferably 25 mass % or less, and even more preferably 20 mass % or less. If the amount of the monomer having the carboxyl group is 1.0 mass % or more, the abrasion resistance is better, and if the amount of the monomer having the carboxyl group is 30 mass % or less, the grip has a better touch feeling in a cold region or in winter.

The amount of the carboxyl group in the XNBR and HXNBR is preferably 1.0 mass % or more, more preferably 2.0 mass % or more, and even more preferably 3.5 mass % or more, and is preferably 30 mass % or less, more preferably 25 mass % or less, and even more preferably 20 mass % or less. If the amount of the carboxyl group is 1.0 mass % or more, the abrasion resistance is better, and if the amount of the carboxyl group is 30 mass % or less, the grip has a better touch feeling in a cold region or in winter.

The Mooney viscosity (ML₁₊₄ (100° C.)) of the HXNBR is preferably 60 or more, more preferably 64 or more, and even more preferably 68 or more, and is preferably 95 or less, more preferably 90 or less, and even more preferably 85 or less. If the Mooney viscosity (ML₁₊₄ (100° C.)) is 60 or more, the grip has further enhanced abrasion resistance, and if the Mooney viscosity (ML₁₊₄ (100° C.)) is 95 or less, the rubber composition has better processability. It is noted that the Mooney viscosity (ML₁₊₄ (100° C.)) in the present disclosure is a value measured according to JIS K6300 using an L rotor under conditions of a preheating time: 1 minute, a rotor rotation time: 4 minutes, and a temperature: 100° C.

### (Liquid Rubber)

The liquid rubber is not particularly limited, as long as it is liquid at a temperature of 25° C. If the liquid rubber is contained, the obtained cured product has a high frictional coefficient.

Examples of the liquid rubber include a liquid diene-based rubber such as a liquid isoprene rubber, a liquid carboxyl-modified isoprene rubber, a liquid farnesene rubber, a liquid farnesene-butadiene copolymer, a liquid styrene-butadiene rubber, a liquid hydrogenated isoprene rubber, a liquid butadiene rubber, and a liquid isoprene-butadiene copolymer; and a liquid non-diene-based rubber such as a liquid butyl rubber. These liquid rubbers may be used solely, or two or more of them may be used in combination.

The liquid rubber is preferably a rubber having an unsaturated carbon-carbon bond. The liquid rubber having the unsaturated carbon-carbon bond can co-crosslink with the solid rubber during curing, and thus bleed is further suppressed.

The liquid rubber is preferably the liquid diene-based rubber, and more preferably at least one member selected from the group consisting of the liquid isoprene rubber, the liquid carboxyl-modified isoprene rubber, the liquid farnesene rubber, the liquid farnesene-butadiene copolymer, the liquid styrene-butadiene rubber, and the liquid hydrogenated isoprene rubber.

The liquid farnesene rubber and the liquid farnesene-butadiene copolymer have a structural unit derived from farnesene. The structural unit derived from farnesene may be a structural unit derived from α-farnesene or a structural unit derived from β-farnesene. It is noted that the structural unit derived from farnesene preferably consists of the structural unit derived from β-farnesene.

The number average molecular weight of the liquid rubber is preferably 20,000 or more, more preferably 25,000 or more, and even more preferably 30,000 or more, and is preferably 150,000 or less, more preferably 140,000 or less, and even more preferably 135,000 or less. If the number average molecular weight of the liquid rubber falls within the above range, kneading with the solid rubber can be easily conducted. The number average molecular weight of the liquid rubber is a number average molecular weight in terms of polystyrene as measured by gel permeation chromatography (GPC).

The viscosity of the liquid rubber is preferably 10 Pa·s or more, more preferably 50 Pa·s or more, and even more preferably 100 Pa·s or more, and is preferably 700 Pa·s or less, more preferably 600 Pa·s or less, and even more preferably 500 Pa·s or less. If the viscosity of the liquid rubber falls within the above range, kneading with the solid rubber can be easily conducted. The viscosity of the liquid rubber is a viscosity of the liquid rubber heated to a temperature of 38° C. measured with a Brookfield viscometer.

The glass transition temperature of the liquid rubber is preferably 0° C. or less, more preferably −10° C. or less, and even more preferably −20° C. or less. If the glass transition temperature of the liquid rubber is 0° C. or less, the rubber composition can be provided with flexibility under a general use environment. The glass transition temperature of the liquid rubber is measured by differential scanning calorimetry. The lower limit of the glass transition temperature of the liquid rubber is not particularly limited, and is −90° C.

The amount of the liquid rubber is preferably 5 parts by mass or more, more preferably 10 parts by mass or more, even more preferably 12 parts by mass or more, and most preferably 14 parts by mass or more, and is preferably 35 parts by mass or less, more preferably 30 parts by mass or less, even more preferably 28 parts by mass or less, and most preferably 26 parts by mass or less, with respect to 100 parts by mass of the solid rubber. If the amount of the liquid rubber is 5 parts by mass or more, the flexibility of the rubber composition can be enhanced, and if the amount of the liquid rubber is 35 parts by mass or less, remarkable lowering in the strength of the rubber composition can be prevented.

### (Vulcanizing Agent)

As the vulcanizing agent, a sulfur vulcanizing agent and an organic peroxide can be used. The vulcanizing agent may be used solely, or two or more of them may be used in combination.

Examples of the sulfur vulcanizing agent include an elemental sulfur and a sulfur donor type compound. Examples of the elemental sulfur include powdery sulfur, precipitated sulfur, colloidal sulfur, and insoluble sulfur. Examples of the sulfur donor type compound include 4,4′-dithiobismorpholine.

Examples of the organic peroxide include dicumyl peroxide, α,α′-bis(t-butylperoxy-m-diisopropyl) benzene, 2,5-dimethyl-2,5-di(t-butylperoxy) hexane, and 1,1-bis(t-butylperoxy)-3,3,5-trimethylcyclohexane.

As the vulcanizing agent, the sulfur vulcanizing agent is preferable, and the elemental sulfur is more preferable. If the sulfur vulcanizing agent is used as the vulcanizing agent, the obtained crosslinked rubber tends to have enhanced mechanical strength. In addition, if the sulfur vulcanizing agent is used, the binding energy between rubber chains is not excessively high, the hysteresis loss is great during the deformation, and the frictional coefficient is improved.

The amount of the vulcanizing agent is preferably 0.2 part by mass or more, more preferably 0.4 part by mass or more, and even more preferably 0.6 part by mass or more, and is preferably 4.0 parts by mass or less, more preferably 3.5 parts by mass or less, and even more preferably 3.0 parts by mass or less, with respect to 100 parts by mass of the solid rubber. If the amount of the vulcanizing agent is 0.2 part by mass or more, the vulcanization more easily progresses, and if the amount of the vulcanizing agent is 4.0 parts by mass or less, occurrence of scorch can be reduced.

### (Vulcanizing Accelerator)

The rubber composition may contain a vulcanizing accelerator. The vulcanizing accelerator may be used solely, or two or more of them may be used in combination.

The total amount of the vulcanizing accelerator in the rubber composition is preferably 4.4 parts by mass or more, more preferably 5.4 parts by mass or more, and even more preferably 6.4 parts by mass or more, and is preferably 12.5 parts by mass or less, more preferably 10.5 parts by mass or less, and even more preferably 8.5 parts by mass or less, with respect to 100 parts by mass of the solid rubber. If the total amount of the vulcanizing accelerator falls within the above range, occurrence of bloom or the like can be further suppressed.

Examples of the vulcanizing accelerator include a thiuram-based vulcanizing accelerator, a sulfenamide-based vulcanizing accelerator, a thiourea-based vulcanizing accelerator, a thiazole-based vulcanizing accelerator, a guanidine-based vulcanizing accelerator, and a dithiocarbamate-based vulcanizing accelerator.

### Thiuram-Based Vulcanizing Accelerator

Examples of the thiuram-based vulcanizing accelerator include tetramethylthiuram disulfide (TMTD), tetrabenzylthiuram disulfide (TBzTD), tetramethylthiuram monosulfide (TMTM), dipentamethylenethiuram tetrasulfide and tetrakis(2-ethylhexyl) thiuram disulfide. The thiuram-based vulcanizing accelerator may be used solely, but two or more of them is preferably used in combination from the viewpoint of preventing the bloom.

The amount of the thiuram-based vulcanizing accelerator is preferably 4 parts by mass or more, more preferably 5 parts by mass or more, and even more preferably 6 parts by mass or more, and is preferably 9 parts by mass or less, more preferably 8 parts by mass or less, and even more preferably 7 parts by mass or less, with respect to 100 parts by mass of the solid rubber. If the amount of the thiuram-based vulcanizing accelerator falls within the above range, a higher speed vulcanization can be achieved while scorch resistance is maintained even if the solid rubber has a small amount of the double bond.

### Sulfenamide-Based Vulcanizing Accelerator

Examples of the sulfenamide-based vulcanizing accelerator include N-cyclohexyl-2-benzothiazolylsulfenamide (CBS), and N-(tert-butyl)-2-benzothiazolsulfenamide (BBS). The sulfenamide-based vulcanizing accelerator may be used solely, or two or more of them may be used in combination.

The amount of the sulfenamide-based vulcanizing accelerator is preferably 0.3 part by mass or more, more preferably 0.5 part by mass or more, and even more preferably 0.7 part by mass or more, and is preferably 2.5 parts by mass or less, more preferably 2.0 parts by mass or less, and even more preferably 1.5 parts by mass or less, with respect to 100 parts by mass of the solid rubber. If the amount of the sulfenamide-based vulcanizing accelerator falls within the above range, occurrence of bloom can be further reduced.

### Thiourea-Based Vulcanizing Accelerator

Examples of the thiourea-based vulcanizing accelerator include trimethylthiourea, and N,N′-diethylthiourea. The thiourea-based vulcanizing accelerator may be used solely, or two or more of them may be used in combination.

The amount of the thiourea-based vulcanizing accelerator is preferably 0.1 part by mass or more, more preferably 0.2 part by mass or more, and even more preferably 0.3 part by mass or more, and is preferably 1.0 part by mass or less, more preferably 0.8 part by mass or less, and even more preferably 0.6 part by mass or less, with respect to 100 parts by mass of the solid rubber. If the amount of the thiourea-based vulcanizing accelerator falls within the above range, the thiuram-based vulcanizing accelerator is activated, and the vulcanizing time can be further shortened.

Examples of the thiazole-based vulcanizing accelerator include mercaptobenzothiazole (MBT), and benzothiazole disulfide.

Examples of the guanidine-based vulcanizing accelerator include diphenylguanidine (DPG).

Examples of the dithiocarbamate-based vulcanizing accelerator include zinc dimethyldithiocarbamate (ZnPDC), and zinc dibutyldithiocarbamate.

The rubber composition preferably contains the thiuram-based vulcanizing accelerator and the sulfenamide-based vulcanizing accelerator as the vulcanizing accelerator. If the thiuram-based vulcanizing accelerator and the sulfenamide-based vulcanizing accelerator are contained, the obtained crosslinked rubber has an excellent mechanical strength even if vulcanization is conducted at a high temperature.

The total amount of the thiuram-based vulcanizing accelerator and the sulfenamide-based vulcanizing accelerator in the rubber composition is preferably 4.5 parts by mass or more, more preferably 5.5 parts by mass or more, and even more preferably 6.5 parts by mass or more, and is preferably 11.5 parts by mass or less, more preferably 10.0 parts by mass or less, and even more preferably 8.5 parts by mass or less, with respect to 100 parts by mass of the solid rubber. If the total amount is 4.5 parts by mass or more, the vulcanizing speed can be further increased even if the solid rubber has a small amount of the double bond, and if the total amount is 11.5 parts by mass or less, the scorch resistance is better when the solid rubber has a small amount of the double bond.

The mass ratio (thiuram-based vulcanizing accelerator/sulfenamide-based vulcanizing accelerator) of the thiuram-based vulcanizing accelerator to the sulfenamide-based vulcanizing accelerator in the rubber composition is preferably 1.5 or more, more preferably 3.0 or more, and even more preferably 4.5 or more, and is preferably 30 or less, more preferably 20 or less, and even more preferably 10 or less. If the mass ratio (thiuram-based vulcanizing accelerator/sulfenamide-based vulcanizing accelerator) is 1.5 or more, the vulcanizing speed can be further increased even if the solid rubber has a small amount of the double bond, and if the mass ratio (thiuram-based vulcanizing accelerator/sulfenamide-based vulcanizing accelerator) is 30 or less, lowering in the strength of the obtained crosslinked rubber can be further suppressed when the vulcanization is conducted at a high temperature and a high speed.

The rubber composition preferably contains the thiuram-based vulcanizing accelerator, the sulfenamide-based vulcanizing accelerator, and the thiourea-based vulcanizing accelerator as the vulcanizing accelerator. If the thiourea-based vulcanizing accelerator is contained, the thiuram-based vulcanizing accelerator is activated, and the vulcanizing time can be further shortened.

The total amount of the thiuram-based vulcanizing accelerator, the sulfenamide-based vulcanizing accelerator and the thiourea-based vulcanizing accelerator in the rubber composition is preferably 4.4 parts by mass or more, more preferably 5.4 parts by mass or more, and even more preferably 6.4 parts by mass or more, and is preferably 12.5 parts by mass or less, more preferably 10.5 parts by mass or less, and even more preferably 9.5 parts by mass or less, with respect to 100 parts by mass of the solid rubber. If the total amount is 4.4 parts by mass or more, the vulcanizing speed can be further increased even if the solid rubber has a small amount of the double bond, and if the total amount is 12.5 parts by mass or less, the scorch resistance is better when the solid rubber has a small amount of the double bond.

The mass ratio (thiuram-based vulcanizing accelerator/thiourea-based vulcanizing accelerator) of the thiuram-based vulcanizing accelerator to the thiourea-based vulcanizing accelerator in the rubber composition is preferably 4 or more, more preferably 6 or more, and even more preferably 8 or more, and is preferably 20 or less, more preferably 18 or less, and even more preferably 16 or less. If the mass ratio (thiuram-based vulcanizing accelerator/thiourea-based vulcanizing accelerator) is 4 or more, the obtained crosslinked rubber has a further enhanced strength, and if the mass ratio (thiuram-based vulcanizing accelerator/thiourea-based vulcanizing accelerator) is 20 or less, activation of the thiuram-based accelerator by the thiourea-based accelerator is further enhanced.

### (Vulcanizing Activator)

The rubber composition may further contain a vulcanizing activator.

Examples of the vulcanizing activator include a metal oxide, a metal peroxide, and a fatty acid. Examples of the metal oxide include zinc oxide, magnesium oxide, and lead oxide. Examples of the metal peroxide include zinc peroxide, chrome peroxide, magnesium peroxide, and calcium peroxide. Examples of the fatty acid include stearic acid, oleic acid, and palmitic acid. These vulcanizing activators may be used solely, or two or more of them may be used in combination.

The total amount of the vulcanizing activator is preferably 0.5 part by mass or more, more preferably 0.6 part by mass or more, and even more preferably 0.7 part by mass or more, and is preferably 10.0 parts by mass or less, more preferably 9.5 parts by mass or less, and even more preferably 9.0 parts by mass or less, with respect to 100 parts by mass of the solid rubber.

### (Thermoplastic Resin)

The rubber composition may contain a thermoplastic resin (excluding a tackifier). If the thermoplastic resin is contained, it is possible to control viscoelastic properties of the cured product of the rubber composition, and improvement in the feeling is achieved. The thermoplastic resin may be used solely, or two or more of them may be used in combination.

When the rubber composition contains the thermoplastic resin, and the amount of the thermoplastic resin is preferably 5 parts by mass or more, more preferably 7 parts by mass or more, and even more preferably 9 parts by mass or more, and is preferably 40 parts by mass or less, more preferably 38 parts by mass or less, and even more preferably 36 parts by mass or less, with respect to 100 parts by mass of the solid rubber. If the amount of the thermoplastic resin is 5 parts by mass or more, the obtained grip has a further enhanced frictional coefficient, and if the amount of the thermoplastic resin is 40 parts by mass or less, lowering in the strength of the cured product of the rubber composition is suppressed.

Examples of the thermoplastic resin include an ethylene-vinyl acetate copolymer and a styrene-based elastomer.

The amount of vinyl acetate in the ethylene-vinyl acetate copolymer is preferably 10 mass % or more, more preferably 12 mass % or more, and even more preferably 15 mass % or more, and is preferably 80 mass % or less, more preferably 75 mass % or less, and even more preferably 70 mass % or less. If the amount of vinyl acetate is 10 mass % or more, the grip has better feeling, and if the amount of vinyl acetate is 80 mass % or less, the grip has further enhanced abrasion resistance.

The Mooney viscosity (ML₁₊₄ (100° C.)) of the ethylene-vinyl acetate copolymer is preferably 20 or more, more preferably 22 or more, and even more preferably 24 or more, and is preferably 40 or less, more preferably 38 or less, and even more preferably 36 or less.

Examples of the styrene-based elastomer include a styrene-butadiene-styrene block copolymer (SBS), a styrene-isobutylene-styrene block copolymer (SIBS), and a styrene-ethylene-butylene-styrene block copolymer (SEBS).

### (Reinforcing Material)

The rubber composition may further contain a reinforcing material. Examples of the reinforcing material include carbon black, silica and calcium carbonate. In addition, if the reinforcing material is contained, the density of the crosslinked rubber can be adjusted, and thus the mass of the grip formed from the rubber composition can be adjusted.

The reinforcing material preferably has a specific surface area in a range from 1 m²/g to 300 m²/g.

When the rubber composition contains the reinforcing material, the amount of the reinforcing material is preferably 9 parts by mass or more, more preferably 14 parts by mass or more, and even more preferably 19 parts by mass or more, and is preferably 36 parts by mass or less, more preferably 30 parts by mass or less, and even more preferably 24 parts by mass or less, with respect to 100 parts by mass of the solid rubber. If the amount of the reinforcing material falls within the above range, the mass of the obtained grip is easily controlled within the desired range.

### (Tackifier)

The rubber composition may further contain a tackifier. When the amount of the reinforcing material in the rubber composition is increased to adjust the density of the crosslinked rubber, the ratio (tan δ/E*) of the crosslinked rubber tends to increase. However, if the tackifier is contained, the ratio (tan δ/E*) can be reduced.

Examples of the tackifier include a rosin ester, a coumarone resin, a phenol resin, a terpene resin, a terpene-phenol resin, and a styrene-based resin.

The rosin ester is an ester compound obtained by a reaction between a rosin and an alcohol. The rosin is a natural resin containing abietic acid, neoabietic acid, palustric acid, pimaric acid, isopimaric acid, and dehydroabietic acid. Examples of the alcohol include a monohydric alcohol such as n-octyl alcohol, 2-ethylhexyl alcohol, decyl alcohol, lauryl alcohol and stearyl alcohol; a dihydric alcohol such as ethylene glycol, diethylene glycol, polyethylene glycol, propylene glycol, dipropylene glycol, polypropylene glycol and neopentyl glycol; a trihydric alcohol such as glycerin and trimethylolpropane; a tetrahydric alcohol such as pentaerythritol and diglycerin; and a hexahydric alcohol such as dipentaerythritol and sorbitol. Among them, the polyhydric alcohol such as the dihydric alcohol or higher alcohol is preferable, and glycerin is more preferable.

Examples of the rosin ester include a hydrogenated rosin ester and a disproportionated rosin ester. The hydrogenated rosin ester and the disproportionated rosin ester are so-called stabilized rosin esters.

The hydrogenated rosin ester is an ester compound where at least a part of the moiety derived from the rosin of the rosin ester is hydrogenated. The hydrogenated rosin ester may be obtained by a method of hydrogenating the rosin followed by carrying out a reaction between the obtained hydrogenated rosin and an alcohol, or a method of carrying out a reaction between the rosin and an alcohol followed by hydrogenating the obtained rosin ester.

The disproportionated rosin ester is an ester compound where at least a part of the moiety derived from the rosin of the rosin ester is disproportionated. The disproportionated rosin ester may be obtained by a method of disproportionating the rosin followed by carrying out a reaction between the obtained disproportionated rosin and an alcohol, or a method of carrying out a reaction between the rosin and an alcohol followed by disproportionating the obtained rosin ester.

The coumarone resin is a resin comprising a coumarone-based compound as the monomer component. As the coumarone resin, a coumarone indene resin is preferable. The coumarone indene resin is a copolymer comprising the coumarone-based compound and an indene-based compound as the monomer component in a total amount of 50 mass % or more in all the monomer components. Examples of the coumarone-based compound include coumarone and methylcoumarone. The amount of the coumarone-based compound in all the monomer components preferably ranges from 1 mass % to 20 mass %. Examples of the indene-based compound include indene and methylindene. The amount of the indene-based compound in all the monomer components preferably ranges from 40 mass % to 95 mass %. The coumarone indene resin may further comprise other monomer components than the coumarone-based compound and the indene-based compound. Examples of the other monomer components include styrene, vinyltoluene, and dicyclopentadiene.

Examples of the phenol resin include a condensation product of a phenol-based compound and formaldehyde. Examples of the phenol-based compound include phenol and m-cresol. In addition, the phenol resin includes a resol obtained by an addition reaction between the phenol-based compound and formaldehyde with an alkali catalyst; and a novolac obtained by a condensation reaction between the phenol-based compound and formaldehyde with an acid catalyst. Further, the phenol resin also includes a rosin phenol resin obtained by an addition of a rosin to the phenol-based compound with an acid catalyst, followed by thermopolymerization reaction.

When the rubber composition contains the tackifier, the amount of the tackifier is preferably 5 parts by mass or more, more preferably 6 parts by mass or more, and even more preferably 7 parts by mass or more, and is preferably 20 parts by mass or less, more preferably 19 parts by mass or less, and even more preferably 18 parts by mass or less, with respect to 100 parts by mass of the solid rubber. If the amount of the tackifier is 5 parts by mass or more, the obtained grip has better feeling, and if the amount of the tackifier is 20 parts by mass or less, lowering in the mechanical strength of the cured product of the rubber composition is suppressed.

### (Processing Aid)

The rubber composition preferably contains a processing aid as well. Examples of the processing aid include an internal lubricant and an external lubricant.

Examples of the internal lubricant include a mineral oil and a plasticizer. Examples of the mineral oil include a paraffin oil, a naphthene oil, and an aromatic oil. Examples of the plasticizer include dioctyl phthalate, dibutyl phthalate, dioctyl sebacate, and dioctyl adipate.

Examples of the external lubricant include a phosphate compound, and a long chain alkylamine compound.

The rubber composition preferably contains the phosphate compound as the external lubricant. If the phosphate compound is contained as the external lubricant, adhesion of the rubber composition to the kneading apparatus during the kneading can be prevented even if a small amount of the phosphate compound is added, and a homogenous rubber composition can be obtained.

When the rubber composition contains the external lubricant, the amount of the external lubricant is preferably 0.1 part by mass or more, more preferably 0.15 part by mass or more, and even more preferably 0.25 part by mass or more, and is preferably 1.0 part by mass or less, more preferably 0.75 part by mass or less, and even more preferably 0.5 part by mass or less, with respect to 100 parts by mass of the solid rubber. If the amount of the external lubricant falls within the above range, the effect as the lubricant is higher, and occurrence of bloom can be suppressed.

The rubber composition may further contain an antioxidant, an anti-scorching agent, a coloring agent, or the like, where necessary.

Examples of the antioxidant include imidazoles, amines, phenols and thioureas. Examples of the imidazoles include nickel dibutyldithiocarbamate (NDIBC), 2-mercaptobenzimidazole, and zinc salt of 2-mercaptobenzimidazole. Examples of the amines include phenyl-α-naphtylamine. Examples of the phenols include 2,2′-methylene bis(4-methyl-6-t-butylphenol) (MBMBP), and 2,6-di-tert-butyl-4-methylphenol. Examples of the thioureas include tributyl thiourea, and 1,3-bis(dimethylaminopropyl)-2-thiourea. These antioxidants may be used solely, or two or more of them may be used in combination.

When the rubber composition contains the antioxidant, the amount of the antioxidant is preferably 0.2 part by mass or more, more preferably 0.3 part by mass or more, and even more preferably 0.4 part by mass or more, and is preferably 5.0 parts by mass or less, more preferably 4.8 parts by mass or less, and even more preferably 4.6 parts by mass or less, with respect to 100 parts by mass of the solid rubber.

Examples of the anti-scorching agent include an organic acid and a nitroso compound. Examples of the organic acid include phthalic anhydride, pyromellitic anhydride, trimellitic anhydride, benzoic acid, salicylic acid, and malic acid. Examples of the nitroso compound include N-nitrosodiphenylamine, N-(cyclohexylthio)phthalimide, sulfonamide derivative, diphenyl urea, bis(tridecyl)pentaerythritol diphosphite, and 2-mercaptobenzimidazole.

Examples of the coloring agent include an inorganic pigment and an organic pigment. Examples of the inorganic pigment include titanium oxide, and particularly the Rutile type titanium oxide is preferable in view of its high opacity. Examples of the organic pigment include an azo pigment and a phthalocyanine pigment.

The rubber composition may contain microballoons. If the microballoons are contained in the rubber composition, a porous grip is obtained. As the microballoons, organic microballoons or inorganic microballoons may be used. Examples of the organic microballoons include hollow particles formed from a thermoplastic resin, and resin capsules encapsulating a hydrocarbon having a low boiling point in a shell formed from a thermoplastic resin.

The rubber composition can be prepared by a conventional method, for example, by kneading various materials with a kneading machine such as a Banbury mixer, a kneader, and an open roll. It is noted that when the rubber composition contains microballoons, the components other than the microballoons are preferably kneaded in advance followed by kneading the kneaded mixture and the microballoons. The material temperature during kneading the kneaded mixture and the microballoons is preferably lower than the expansion starting temperature of the microballoons.

### (Vulcanization Characteristics)

The 90% vulcanizing time (t90) of the above-mentioned rubber composition in a vulcanization curve measured at a vulcanizing temperature of 185° C. is preferably 5 min or less, more preferably 4.5 min or less, and even more preferably 4 min or less. If the 90% vulcanizing time is 5 min or less, the productivity is higher. The lower limit of the 90% vulcanizing time is not particularly limited, and is generally 3 min.

The 90% vulcanizing time is obtained from the vulcanization curve measured at the vulcanizing temperature of 185° C. Specifically, when the minimum value of the torque is ML, the maximum value of the torque is MH, and the difference between them is ME in the vulcanization curve, the time required by the torque to become ML+90% ME is defined as the 90% vulcanizing time.

### (Crosslinked Rubber)

The cured product (crosslinked rubber) obtained by curing the above-mentioned rubber composition preferably has the properties described later. It is noted that the vulcanizing condition when vulcanizing the rubber composition is as follows. The vulcanizing temperature is 185° C., and the vulcanizing time is the 90% vulcanizing time (t90) in the vulcanization curve plus 2 minutes.

The ratio (tan δ/E*) of the loss tangent (tan δ) to the complex elastic modulus (E*) (MPa) of the cured product of the rubber composition at a temperature of 25° C. is 0.030 or more, preferably 0.032 or more, more preferably 0.034 or more, and is 0.045 or less, preferably 0.044 or less, more preferably 0.043 or less, wherein the loss tangent (tan δ) and the complex elastic modulus (E*) (MPa) are measured with a dynamic viscoelastic spectrometer under measuring conditions of an oscillation frequency: 10 Hz, a strain amplitude: 0.05% and a tensile mode.

The loss tangent (tan δ) of the cured product of the rubber composition at the temperature of 25° C. is preferably 0.10 or more, more preferably 0.12 or more, and even more preferably 0.14 or more, wherein the loss tangent (tan δ) is measured with the dynamic viscoelastic spectrometer under the measuring conditions of the oscillation frequency: 10 Hz, the strain amplitude: 0.05% and the tensile mode. If the loss tangent (tan δ) is 0.10 or more, the obtained grip has a better anti-slipping performance.

The upper limit of the loss tangent (tan δ) is not particularly limited, and preferably 0.26 or less, more preferably 0.24 or less, and even more preferably 0.23 or less. If the loss tangent (tan δ) is 0.26 or less, excessive deflection of the cured product of the rubber composition can be suppressed.

The complex elastic modulus (E*) of the cured product of the rubber composition at the temperature of 25° C. is preferably 8.00 MPa or less, more preferably 7.90 MPa or less, and even more preferably 7.80 MPa or less, wherein the complex elastic modulus (E*) is measured with the dynamic viscoelastic spectrometer under the measuring conditions of the oscillation frequency: 10 Hz, the strain amplitude: 0.05% and the tensile mode. If the complex elastic modulus (E*) is 8.00 MPa or less, excessive hardening of the cured product of the rubber composition can be suppressed.

The lower limit of the complex elastic modulus (E*) is not particularly limited, and is preferably 3.00 MPa or more, more preferably 3.20 MPa or more, and even more preferably 3.40 MPa or more. If the complex elastic modulus (E*) is 3.00 MPa or more, the hardness of the cured product of the rubber composition is more suitable for the grip.

The density of the cured product of the rubber composition is preferably 1.05 g/cm³ or more, more preferably 1.06 g/cm³ or more, and even more preferably 1.07 g/cm³ or more, and is preferably 1.10 g/cm³ or less, more preferably 1.09 g/cm³ or less, and even more preferably 1.08 g/cm³ or less. If the density falls within the above range, the single layered grip formed from the above-mentioned rubber composition has a weight at a same level as a conventional grip, and thus can replace the conventional grip without any problem.

The hardness of the cured product of the rubber composition is preferably 50 or more, more preferably 51 or more, and even more preferably 52 or more, and is preferably 60 or less, more preferably 59 or less, and even more preferably 58 or less in Shore A hardness. If the hardness of the cured product is 50 or more in Shore A hardness, the grip has further enhanced mechanical strength, and if the hardness of the cured product is 60 or less, the grip is not excessively hard, and thus has better feeling when it is grasped.

The tensile strength at break (Tb) of the cured product of the rubber composition is preferably 9 MPa or more, more preferably 11 MPa or more, and even more preferably 13 MPa or more. If the tensile strength at break is 9 MPa or more, the grip has better abrasion resistance. The upper limit of the tensile strength at break of the cured product of the rubber composition is not particularly limited, and is preferably 40 MPa or less, more preferably 38 MPa or less, and even more preferably 26 MPa or less.

The elongation at break (Eb) of the cured product of the rubber composition is preferably 300% or more, more preferably 320% or more, and even more preferably 340% or more. If the elongation at break is 300% or more, occurrence of a problem that the grip breaks when inserting the shaft to the grip can be further suppressed. The upper limit of the elongation at break of the cured product of the rubber composition is not particularly limited, and is generally 800%.

The grip rubber composition according to the present disclosure is used to mold a grip. The grip rubber composition has an excellent frictional coefficient after it is cured, and thus can be suitably used for a golf club grip.

### [Golf Club Grip]

The golf club grip according to the present disclosure has a cylindrical portion, wherein at least one part of the cylindrical portion is formed from the above-mentioned grip rubber composition. In other words, at least one part of the cylindrical portion is composed of the crosslinked rubber obtained by vulcanizing the grip rubber composition.

The golf club grip has the cylindrical portion for inserting the shaft. Examples of the construction of the cylindrical portion include a single layered structure, a dual layered structure, and a triple layered structure. When the cylindrical portion is single layered, the whole cylindrical portion is formed from the rubber composition. When the cylindrical portion is multilayered, at least one layer thereof is formed from the rubber composition. It is noted that when the cylindrical portion is multilayered, it is preferable that the outermost layer thereof is at least formed from the rubber composition.

The cylindrical portion of the golf club grip is preferably single layered. The above-mentioned grip rubber composition can be vulcanized at a high temperature, and thus a thick member can be molded therefrom in a short time. For this reason, if the single layered cylindrical portion is produced from the above-mentioned grip rubber composition, the productivity of the grip is further enhanced because of a simple construction and shortened vulcanizing time. In addition, if the density of the crosslinked rubber formed from the rubber composition ranges from 1.05 g/cm³ to 1.10 g/cm³, the single layered grip formed from the above-mentioned rubber composition has a weight at a same level as a conventional grip, and thus can replace the conventional grip without any problem.

The cylindrical portion may be solid or porous. If the cylindrical portion is solid, the grip has a high mechanical strength, and if the cylindrical portion is porous, it is possible to reduce the weight of the grip.

The golf club grip may be obtained by molding the rubber composition in a mold. Examples of the molding method include a press molding method and an injection molding method. In addition, the golf club grip having the inner layer and the outer layer may be obtained, for example, by press molding a laminated product composed of an unvulcanized rubber sheet formed from the outer layer rubber composition and an unvulcanized rubber sheet formed from the inner layer rubber composition in a mold.

### [Golf Club]

The present disclosure also includes a golf club using the above golf club grip. The golf club comprises a shaft, a head provided on one end of the shaft, and a grip provided on another end of the shaft, wherein the grip is the golf club grip according to the present disclosure. The shaft can be made of stainless steel or a carbon fiber reinforced resin. Examples of the head include a wood type, a utility type, and an iron type. The material constituting the head is not particularly limited, and examples thereof include titanium, titanium alloy, carbon fiber reinforced plastic, stainless steel, maraging steel and soft iron.

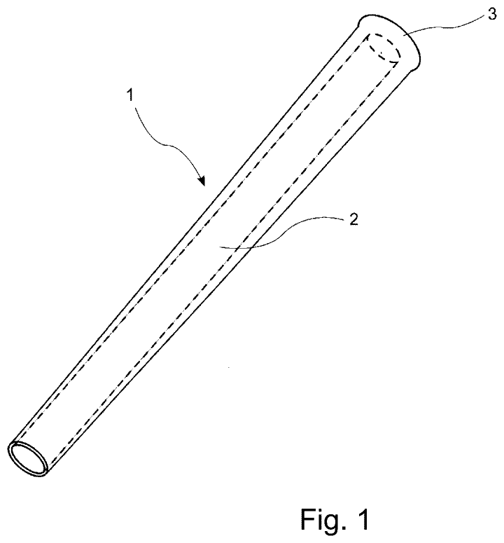

Next, the golf club grip and the golf club will be explained with reference to figures. FIG. 1 is a perspective view showing one example of a golf club grip. A grip 1 comprises a cylindrical portion 2 for inserting a shaft, and an integrally molded cap portion 3 for covering the opening of the back end of the cylindrical portion. The cylindrical portion 2 is single layered. The cylindrical portion 2 is formed with a thickness gradually becoming thicker from the front end part toward the back end part. In the grip 1 shown in FIG. 1, the cap portion 3 is formed from the same rubber composition as that used in the cylindrical portion 2.

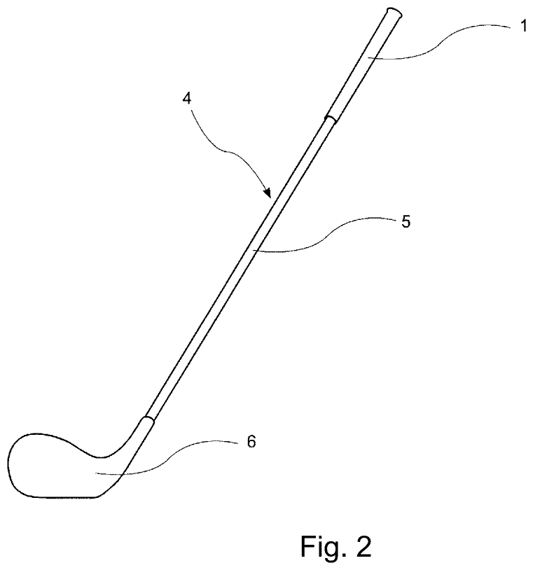

FIG. 2 is a perspective view showing one example of a golf club provided with the golf club grip 1 according to the present disclosure. A golf club 4 comprises a shaft 5, a head 6 provided on one end of the shaft 5, and the grip 1 provided on another end of the shaft 5. The back end of the shaft 5 is inserted into the cylindrical portion 2 of the grip 1.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Method]

### (1) Amount of Acrylonitrile

The amount of acrylonitrile in the acrylonitrile-butadiene rubber before hydrogenation was measured according to ISO 24698-1 (2008).

### (2) Amount of Double Bond (Mmol/g)

The amount of the double bond is calculated from the amount (mass %) of butadiene in the copolymer and the amount (%) of a residual double bond. The amount of the residual double bond is a mass ratio (amount of the double bond after hydrogenation/amount of the double bond before hydrogenation) of the double bond in the copolymer after hydrogenation to the double bond in the copolymer before hydrogenation, and can be measured by infrared spectroscopy. In the case that the acrylonitrile-butadiene rubber is an acrylonitrile-butadiene binary copolymer, the amount of butadiene in the copolymer is calculated by subtracting the amount (mass %) of acrylonitrile from 100.

Amount of double bond={amount of butadiene/54}×amount of residual double bond×10

### (3) Amount of a Monomer Having a Carboxyl Group

1 g of the hydrogenated carboxyl-modified acrylonitrile-butadiene rubber was weighed and dissolved in 50 ml of chloroform, a thymol blue indicator was dripped therein. 0.05 mol/L sodium hydroxide methanol solution was dripped into the solution while the solution was stirred, and the dripping amount (V ml) at the time the solution color initially changed was recorded. Regarding a blank, i.e. 50 ml of chloroform not containing the hydrogenated carboxyl-modified acrylonitrile-butadiene rubber, thymol blue was used as the indicator, 0.05 mol/L sodium hydroxide methanol solution was dripped into the solution, and the dripping amount (B ml) at the time the solution color initially changed was recorded. The amount of the carboxyl group was calculated according to the following formula.

Amount of a monomer having a carboxyl group={0.05×(V−B)×PM}/(10×X)

(In the formula, V: dripping amount (ml) of sodium hydroxide solution in test solution, B: dripping amount (ml) of sodium hydroxide solution in blank, PM: molecular weight of a monomer having a carboxyl group, X: valence of a monomer having a carboxyl group)

### (4) Vulcanizing Test

The vulcanizing test for the rubber composition was conducted with a curemeter (CURELASTOMETER (registered trademark) Type 7 available from JSR Trading Co., Ltd.) at the vulcanizing temperature described in Table 2. A sinusoidal oscillation with a low amplitude that does not destroy the rubber test piece was applied to the rubber test piece from a lower die, and the torque transmitted from the test piece to an upper die from the time at which the test piece was unvulcanized to the time at which the test piece was overvulcanized was measured according to “9. Die vulcanizing test method A” of “Measurement of vulcanization characteristics with oscillating curemeters” of JIS K6300-2 (2001). The measuring conditions were a torsional oscillation frequency of 100 times per minute, an amplitude angle of 1°, and a measuring time of 30 minutes. The minimum value (ML) and maximum value (MH) of the torque, and the 90% vulcanizing time (t90) were obtained from the obtained vulcanization curve.

### (5) Hardness (Shore A Hardness)

Sheets with a thickness of 2 mm were formed by vulcanizing the rubber composition under the conditions described in Table 2. The sheets were stored at a temperature of 23° C. for two weeks. Three of these sheets were stacked on one another so as not to be affected by the measuring base on which the sheets were placed, and the hardness of the stack was measured with an automatic hardness tester (Digitest II, available from Bareiss company) using a testing device of “Shore A”.

(6) Density (g/Cm³)

The rubber composition was vulcanized under the conditions described in Table 2 to prepare a square sheet with a side length of 13 cm and a thickness of 2 mm, and a test piece having a square shape with a side length of 2 cm was cut out from the sheet to prepare a test piece. The density of the obtained test piece was measured with an automatic gravimeter (SP-GR1 available from MS-technical, Inc., Archimedes' principle).

### (7) Tensile Strength at Break (MPa) and Elongation at Break (%)

The tensile strength at break and the elongation at break were measured according to JIS K 6251 (2017). Specifically, the rubber composition was vulcanized under the conditions described in Table 2 to prepare a sheet with a thickness of 1 mm, and a test piece having a dumbbell shape (Dumbbell shape No. 3) was cut out from the sheet. The physical properties of the test piece were measured with a tensile tester (Autograph (registered trademark) AGS-D available from Shimadzu Corporation) (measuring temperature: 23° C., tensile speed: 500 mm/min). In addition, the tensile strength at break was calculated by dividing the tensile force recorded when the test piece was broken by the cross-sectional area of the test piece before the test.

### (8) Viscoelasticity

The loss tangent (tan δ) and the complex elastic modulus (E*) were measured with a dynamic viscoelastic spectrometer (Rheogel-E4000 available from UBM KK).

A test sample was prepared by slicing the grip with a thickness of 1.6 mm along the thickness direction, and a test sample having a determined size was cut out from the slice. The measuring conditions were: a temperature of −100° C. to 100° C., a temperature rising rate of 3° C./min, a measuring interval of 3° C., a frequency of 10 Hz, a strain amplitude of 10%, a jig of a tensile mode, and a sample dimension of width: 4 mm, thickness: 2 mm and length: 40 mm. The loss tangent (tan δ) and the complex elastic modulus (E*) at a temperature of 25° C. were calculated from the viscoelastic spectrum obtained by the dynamic viscoelastic measurement.

### (9) Frictional Coefficient

The frictional coefficient was measured with a static-dynamic friction tester (TRILAB MASTER available from Trinity-Lab Inc.).

A test sample was prepared by slicing the grip with a thickness of 1.6 mm along the thickness direction, removing the groove pattern, and a test sample having a width of 10 mm and a length of 20 mm was cut out from the slice. The test sample was fixed to the flat contactor of the tester. In addition, a natural leather cut from the palm of a golf glove (XXIO (registered trademark) Golf Glove (GGG-X008) available from Sumitomo Rubber Industries, Ltd.) was fixed to the moving table.

The measuring conditions were: a load of 25 g, a moving speed of 1 mm/sec, and a moving distance of 10 mm. An average value of dynamic frictional coefficients measured in a period time of 2000 ms to 6000 ms from the start of the measurement was calculated.

It is noted that the frictional coefficient of the crosslinked rubber No. 10 was defined as an index of 100, and the frictional coefficient is a value represented by converting the frictional coefficient into this index.

### [Preparation of Rubber Composition]

According to the formulations shown in Table 1, the materials were kneaded to prepare the rubber compositions. It is noted that all the materials of the rubber composition were kneaded in a closed type kneading machine.

TABLE 1

| Rubber composition No. | | | A | B | C | D | E | F | G | H |
|---|---|---|---|---|---|---|---|---|---|---|
| Formulation | Solid rubber | HXNBR | 100 | 100 | 100 | 100 | 100 | 100 | 100 | 100 |
| (parts by | Liquid rubber | Liquid IR | — | — | — | — | — | — | 10 | 20 |
| mass) | | Liquid carboxyl- | — | — | — | — | — | — | — | — |
| | | modified IR | | | | | | | | |
| | | Liquid farnesene | — | — | — | — | — | — | — | — |
| | | Liquid farnesene- | — | — | — | — | — | — | — | — |
| | | butadiene copolymer | | | | | | | | |
| | Vulcanizing | Sulfur | 1.5 | 1.5 | 1.5 | 1.5 | 1.5 | 1.5 | 1.5 | 1.5 |
| | agent | | | | | | | | | |
| | Vulcanizing | Zinc peroxide | 5 | 5 | 5 | 5 | 5 | 5 | 5 | 5 |
| | activator | | | | | | | | | |
| | Vulcanizing | Thiuram-based | 3 | 3 | 3 | 3 | 3 | 3 | 3 | 3 |
| | accelerator | accelerator 1 | | | | | | | | |
| | | Thiuram-based | 3 | 3 | 3 | 3 | 3 | 3 | 3 | 3 |
| | | accelerator 2 | | | | | | | | |
| | | Thiourea-based | 0.5 | 0.5 | 0.5 | 0.5 | 0.5 | 0.5 | 0.5 | 0.5 |
| | | accelerator | | | | | | | | |
| | | Sulfenamide-based | 1 | 1 | 1 | 1 | 1 | 1 | 1 | 1 |
| | | accelerator | | | | | | | | |
| | Resin | EVA | 30 | 30 | 30 | 30 | 30 | 30 | 30 | 30 |
| | Tackifier | Solid tackifier | 8 | — | — | 8 | 8 | 8 | 8 | 8 |
| | | Liquid tackifier | — | 8 | 16 | 8 | — | — | — | — |
| | Reinforcing | Carbon black | 15 | — | — | — | — | 15 | 13 | 13 |
| | material | Silica | 5 | 10 | 33 | 33 | 13 | — | 8 | 8 |
| | | Calcium carbonate | — | — | — | — | 4 | 6 | — | — |
| | Pigment | Rutile type titanium | — | — | 1 | 1 | 1 | — | — | — |
| | | oxide | | | | | | | | |
| | External | vanfre VAM | 0.25 | 0.25 | 0.25 | 0.25 | 0.25 | 0.25 | 0.25 | 0.25 |
| | lubricant | | | | | | | | | |

| Rubber composition No. | | | I | J | K | L | M | N | O |
|---|---|---|---|---|---|---|---|---|---|
| Formulation | Solid rubber | HXNBR | 100 | 100 | 100 | 100 | 100 | 100 | 100 |
| (parts by | Liquid rubber | Liquid IR | 30 | — | — | — | — | — | — |
| mass) | | Liquid carboxyl- | — | 10 | 20 | 30 | — | — | — |
| | | modified IR | | | | | | | |
| | | Liquid farnesene | — | — | — | — | 10 | — | — |
| | | Liquid farnesene- | — | — | — | — | — | 20 | 30 |
| | | butadiene copolymer | | | | | | | |
| | Vulcanizing | Sulfur | 1.5 | 1.5 | 1.5 | 1.5 | 1.5 | 1.5 | 1.5 |
| | agent | | | | | | | | |
| | Vulcanizing | Zinc peroxide | 5 | 5 | 5 | 5 | 5 | 5 | 5 |
| | activator | | | | | | | | |
| | Vulcanizing | Thiuram-based | 3 | 3 | 3 | 3 | 3 | 3 | 3 |
| | accelerator | accelerator 1 | | | | | | | |
| | | Thiuram-based | 3 | 3 | 3 | 3 | 3 | 3 | 3 |
| | | accelerator 2 | | | | | | | |
| | | Thiourea-based | 0.5 | 0.5 | 0.5 | 0.5 | 0.5 | 0.5 | 0.5 |
| | | accelerator | | | | | | | |
| | | Sulfenamide-based | 1 | 1 | 1 | 1 | 1 | 1 | 1 |
| | | accelerator | | | | | | | |
| | Resin | EVA | 30 | 30 | 30 | 30 | 30 | 30 | 30 |
| | Tackifier | Solid tackifier | 8 | 8 | 8 | 8 | 8 | 8 | 8 |
| | | Liquid tackifier | — | — | — | — | — | — | — |
| | Reinforcing | Carbon black | 13 | 13 | 13 | 13 | 13 | 13 | 13 |
| | material | Silica | 8 | 8 | 8 | 8 | 8 | 8 | 8 |
| | | Calcium carbonate | — | — | — | — | — | — | — |
| | Pigment | Rutile type titanium | — | — | — | — | — | — | — |
| | | oxide | | | | | | | |
| | External | vanfre VAM | 0.25 | 0.25 | 0.25 | 0.25 | 0.25 | 0.25 | 0.25 |
| | lubricant | | | | | | | | |

Materials used in Table 1 are shown as follows.
HXNBR: hydrogenated carboxyl-modified acrylonitrile-butadiene rubber (Therban XT VPKA 8889 (amount of residual double bond: 3.5%, amount of acrylonitrile: 33.0 mass %, amount of double bond: 0.40 mmol/g, amount of carboxyl group-containing monomer: 5.0 mass %) available from ARANXEO Corporation)
Liquid IR: “LIR-50” (liquid isoprene rubber, isoprene homopolymer, molecular weight: 54,000, viscosity: 500 Pa·s (38° C.), glass transition temperature: −63° C.) available from Kuraray Co., Ltd.
Liquid carboxyl-modified IR: “LIR-410” (liquid carboxyl-modified isoprene rubber, molecular weight: 30,000, viscosity: 430 Pa·s (38° C.), glass transition temperature: −59° C., number of functional groups per one molecule: 10) available from Kuraray Co., Ltd.
Liquid farnesene: “L-FR-107L” (liquid farnesene rubber, farnesene homopolymer, molecular weight: 130,000, viscosity: 69 Pa·s (38° C.), glass transition temperature: −70° C.) available from Kuraray Co., Ltd.
Liquid farnesene-butadiene copolymer: “L-FBR-746” (liquid farnesene-butadiene random copolymer, molecular weight: 100,000, viscosity: 603 Pa·s (38° C.), glass transition temperature: −78° C.) available from Kuraray Co., Ltd.
Sulfur: “GOLDEN FLOWER” 5% oil treated sulfur fine powder (200 mesh) available from Tsurumi Chemical Industry Co., Ltd.
Zinc peroxide: Struktol ZP 1014 (amount of zinc peroxide: 29 mass %) available from Struktol Company
Thiuram-based accelerator 1: “Sanceller (registered trademark) TBzTD” (tetrabenzylthiuram disulfide) available from Sanshin Chemical Industry Co., Ltd.
Thiuram-based accelerator 2: “Nocceler (registered trademark) TOT-N” (tetrakis(2-ethylhexyl)thiuram disulfide) available from Ouchi Shinko Chemical Industry Co., Ltd.
Thiourea-based accelerator: “Nocceler EUR” (N,N′-diethylthiourea) available from Ouchi Shinko Chemical Industry Co., Ltd.
Sulfenamide-based accelerator: “Sanceller NS-G” (N-(tert-butyl)-2-benzothiazolylsulfenamide)) available from Sanshin Chemical Industry Co., Ltd.
EVA: ethylene-vinyl acetate copolymer (Levapren 500 (amount of vinyl acetate: 50 mass %, Mooney viscosity (ML₁₊₄ (100° C.): 27) available from ARANXEO Corporation)
Solid tackifier: “Staybelite Ester 10-E” (partially hydrogenated rosin ester) available from Eastman Chemical Company
Liquid tackifier: “SYLVATAC RE-5S” (rosin ester (melting point: 25° C. or less)) available from Arizona Chemical Company
Carbon black: SEAST (registered trademark) 3 (specific surface area: 79 m²/g) available from Tokai Carbon Co., Ltd.
Silica: Nipsil (registered trademark) VN3 (specific surface area: 180 to 230 m²/g) available from Tosoh Silica Corporation
Calcium carbonate: SOFTON 3200 (specific surface area: 3.2 m²/g) available from Shiraishi Calcium Kaisha, Ltd.
Rutile type titanium oxide: CR60 available from Ishihara Sangyo kaisha, Ltd.
vanfre VAM: polyoxyethylene-octadecyl ether-phosphoric acid available from Vanderbilt Chemicals, LLC

### [Production of Grip]

The rubber composition was charged into a mold provided with a groove pattern on the cavity surface. Then, the rubber composition was vulcanized under the conditions described in Table 2 to carry out a crosslinking reaction of the rubber, thereby obtaining the golf club grips. The viscoelastic properties and frictional coefficient of the grips were evaluated, and the results were shown in Table 2.

TABLE 2

| Crosslinked rubber No. | | | 1 | 2 | 3 | 4 | 5 |
|---|---|---|---|---|---|---|---|
| Used rubber composition No. | | | G | H | I | J | K |
| Vulcanizing | Vulcanizing temperature (° C.) | | 185 | 185 | 185 | 185 | 185 |
| test | t90 (min) | | 2 | 2 | 2 | 2 | 2 |
| Properties | Vulcanizing | Vulcanizing temperature (° C.) | 185 | 185 | 185 | 185 | 185 |
| of | condition | Vulcanizing time (min) | 4 | 4 | 4 | 4 | 4 |
| crosslinked | Density (g/cm³) | | 1.06 | 1.05 | 1.05 | 1.07 | 1.06 |
| rubber | Hardness (Shore A) | | 54 | 53 | 55 | 54 | 55 |
| | Tensile strength at break Tb (MPa) | | 20 | 15 | 14 | 17 | 14 |
| | Elongation at break Eb (%) | | 590 | 575 | 530 | 640 | 705 |
| Properties | Vulcanizing | Vulcanizing temperature (° C.) | 185 | 185 | 185 | 185 | 185 |
| of grip | condition | Vulcanizing time (min) | 4 | 4 | 4 | 4 | 4 |
| | Viscoelasticity | Complex elastic modulus E* (MPa) | 5.22 | 4.96 | 4.98 | 6.00 | 5.50 |
| | | Loss tangent tanδ | 0.211 | 0.202 | 0.213 | 0.247 | 0.203 |
| | | Ratio (tanδ/E*) | 0.040 | 0.041 | 0.043 | 0.041 | 0.037 |
| | Frictional coefficient | | 118 | 131 | 123 | 117 | 121 |
| Crosslinked rubber No. | | | 6 | 7 | 8 | 9 | 10 |
| Used rubber composition No. | | | L | M | N | O | A |
| Vulcanizing | Vulcanizing temperature (° C.) | | 185 | 185 | 185 | 185 | 185 |
| test | t90 (min) | | 2 | 2 | 2 | 2 | 3 |
| Properties | Vulcanizing | Vulcanizing temperature (° C.) | 185 | 185 | 185 | 185 | 185 |
| of | condition | Vulcanizing time (min) | 4 | 4 | 4 | 4 | 5 |
| crosslinked | Density (g/cm³) | | 1.05 | 1.07 | 1.06 | 1.05 | 1.07 |
| rubber | Hardness (Shore A) | | 57 | 55 | 53 | 54 | 56 |
| | Tensile strength at break Tb (MPa) | | 12 | 19 | 17 | 13 | 28 |
| | Elongation at break Eb (%) | | 713 | 574 | 566 | 528 | 494 |
| Properties | Vulcanizing | Vulcanizing temperature (° C.) | 185 | 185 | 185 | 185 | 185 |
| of grip | condition | Vulcanizing time (min) | 4 | 4 | 4 | 4 | 5 |
| | Viscoelasticity | Complex elastic modulus E* (MPa) | 5.18 | 5.29 | 5.43 | 5.31 | 5.49 |
| | | Loss tangent tanδ | 0.185 | 0.222 | 0.200 | 0.205 | 0.234 |
| | | Ratio (tanδ/E*) | 0.036 | 0.042 | 0.037 | 0.039 | 0.043 |
| | Frictional coefficient | | 142 | 120 | 113 | 113 | 100 |
| Crosslinked rubber No. | | | 11 | 12 | 13 | 14 | 15 |
| Used rubber composition No. | | | B | C | D | E | F |
| Vulcanizing | Vulcanizing temperature (° C.) | | 185 | 185 | 185 | 185 | 185 |
| test | t90 (min) | | 4 | 3 | 3 | 4 | 3 |
| Properties | Vulcanizing | Vulcanizing temperature (° C.) | 185 | 185 | 185 | 185 | 185 |
| of | condition | Vulcanizing time (min) | 6 | 5 | 5 | 6 | 5 |
| crosslinked | Density (g/cm³) | | 1.04 | 1.10 | 1.10 | 1.06 | 1.08 |
| rubber | Hardness (Shore A) | | 50 | 57 | 62 | 52 | 55 |
| | Tensile strength at break Tb (MPa) | | 25 | 27 | 29 | 24 | 25 |
| | Elongation at break Eb (%) | | 571 | 577 | 573 | 583 | 502 |
| Properties | Vulcanizing | Vulcanizing temperature (° C.) | 185 | 185 | 185 | 185 | 185 |
| of grip | condition | Vulcanizing time (min) | 6 | 5 | 5 | 6 | 5 |
| | Viscoelasticity | Complex elastic modulus E* (MPa) | 4.56 | 9.73 | 8.53 | 5.59 | 4.32 |
| | | Loss tangent tanδ | 0.240 | 0.203 | 0.217 | 0.277 | 0.249 |
| | | Ratio (tanδ/E*) | 0.053 | 0.021 | 0.025 | 0.049 | 0.058 |

| | | | | | |
|---|---|---|---|---|---|
| Frictional coefficient | 97 | 86 | 90 | 98 | 90 |

The base rubber of the rubber compositions No. G to O contains a solid rubber that is a solid at a temperature of 25° C. and a liquid rubber that is a liquid at a temperature of 25° C. The crosslinked rubbers No. 1 to 9 are the cured products of these rubber compositions No. G to O The ratio (tan δ/E*) of the loss tangent (tan δ) to the complex elastic modulus (E*) (MPa) of the crosslinked rubbers No. 1 to No. 9 ranges from 0.030 to 0.045 at the temperature of 25° C.

The grips produced from these rubber compositions No. G to O had a great frictional coefficient.

The base rubber of the rubber compositions No. A to F does not contain a liquid rubber that is a liquid at a temperature of 25° C. The crosslinked rubbers No. 10 to 15 are the cured products of these rubber compositions No. B to F. The ratio (tan δ/E*) of the loss tangent (tan δ) to the complex elastic modulus (E*) (MPa) of the crosslinked rubbers No. 10 to No. 15 is less than 0.030 or more than 0.045.

The grips produced from these rubber compositions No. A to F had a low frictional coefficient.

The present disclosure (1) is a grip rubber composition containing a base rubber and a vulcanizing agent, wherein the base rubber contains a solid rubber that is a solid at a temperature of 25° C. and a liquid rubber that is a liquid at a temperature of 25° C., and a ratio (tan δ/E*) of a loss tangent (tan δ) to a complex elastic modulus (E*) (MPa) of a cured product of the grip rubber composition at a temperature of 25° C. ranges from 0.030 to 0.045, wherein the loss tangent (tan δ) and the complex elastic modulus (E*) (MPa) are measured with a dynamic viscoelastic spectrometer under measuring conditions of an oscillation frequency: 10 Hz, a strain amplitude: 0.05% and a tensile mode.

The present disclosure (2) is the grip rubber composition according to the present disclosure (1), wherein a cured product of the grip rubber composition has a tensile strength at break of 9 MPa or more.

The present disclosure (3) is the grip rubber composition according to the present disclosure (1) or (2), wherein the solid rubber contains at least one member selected from the group consisting of a carboxyl-modified acrylonitrile-butadiene rubber, a hydrogenated acrylonitrile-butadiene rubber and a hydrogenated carboxyl-modified acrylonitrile-butadiene rubber.

The present disclosure (4) is the grip rubber composition according to any one of the present disclosures (1) to (3), wherein the liquid rubber is a rubber having an unsaturated carbon-carbon bond.

The present disclosure (5) is the grip rubber composition according to any one of the present disclosures (1) to (4), wherein a cured product of the grip rubber composition has a density in a range from 1.05 g/cm³ to 1.10 g/cm³.

The present disclosure (6) is the grip rubber composition according to any one of the present disclosures (1) to (5), wherein a cured product of the grip rubber composition has a hardness in a range from 50 to 60 in Shore A hardness.

The present disclosure (7) is a golf club grip comprising a cylindrical portion, wherein at least one part of the cylindrical portion is formed from the grip rubber composition according to any one of the present disclosures (1) to (6).

This application is based on Japanese patent application No. 2024-196757 filed on Nov. 11, 2024, the content of which is hereby incorporated by reference.

1. A grip rubber composition containing a base rubber and a vulcanizing agent, wherein
the base rubber contains a solid rubber that is a solid at a temperature of 25° C. and a liquid rubber that is a liquid at a temperature of 25° C., and
a ratio (tan δ/E*) of a loss tangent (tan δ) to a complex elastic modulus (E*) (MPa) of a cured product of the grip rubber composition at a temperature of 25° C. ranges from 0.030 to 0.045, wherein the loss tangent (tan δ) and the complex elastic modulus (E*) (MPa) are measured with a dynamic viscoelastic spectrometer under measuring conditions of an oscillation frequency: 10 Hz, a strain amplitude: 0.05% and a tensile mode.

2. The grip rubber composition according to claim 1, wherein the cured product of the grip rubber composition has a tensile strength at break of 9 MPa or more.

3. The grip rubber composition according to claim 1, wherein the solid rubber contains at least one member selected from the group consisting of a carboxyl-modified acrylonitrile-butadiene rubber, a hydrogenated acrylonitrile-butadiene rubber and a hydrogenated carboxyl-modified acrylonitrile-butadiene rubber.

4. The grip rubber composition according to claim 1, wherein the liquid rubber is a rubber having an unsaturated carbon-carbon bond.

5. The grip rubber composition according to claim 1, wherein the cured product of the grip rubber composition has a density in a range from 1.05 g/cm³ to 1.10 g/cm³.

6. The grip rubber composition according to claim 1, wherein the cured product of the grip rubber composition has a hardness in a range from 50 to 60 in Shore A hardness.

7. The grip rubber composition according to claim 1, wherein the liquid rubber is at least one member selected from the group consisting of a liquid isoprene rubber, a liquid carboxyl-modified isoprene rubber, a liquid farnesene rubber, a liquid farnesene-butadiene copolymer, a liquid styrene-butadiene rubber, and a liquid hydrogenated isoprene rubber.

8. The grip rubber composition according to claim 1, wherein an amount of the liquid rubber ranges from 5 parts by mass to 35 parts by mass with respect to 100 parts by mass of the solid rubber.

9. The grip rubber composition according to claim 1, wherein the liquid rubber has a number average molecular weight in a range from 20,000 to 150,000.

10. The grip rubber composition according to claim 1, wherein the liquid rubber has a glass transition temperature of 0° C. or less.

11. A golf club grip comprising a cylindrical portion, wherein at least one part of the cylindrical portion is formed from a grip rubber composition containing a base rubber and a vulcanizing agent, wherein
the base rubber contains a solid rubber that is a solid at a temperature of 25° C. and a liquid rubber that is a liquid at a temperature of 25° C., and
a ratio (tan δ/E*) of a loss tangent (tan δ) to a complex elastic modulus (E*) (MPa) of a cured product of the grip rubber composition at a temperature of 25° C. ranges from 0.030 to 0.045, wherein the loss tangent (tan δ) and the complex elastic modulus (E*) (MPa) are measured with a dynamic viscoelastic spectrometer under measuring conditions of an oscillation frequency: 10 Hz, a strain amplitude: 0.05% and a tensile mode.

12. The golf club grip according to claim 11, wherein the cured product of the grip rubber composition has a tensile strength at break of 9 MPa or more.

13. The golf club grip according to claim 11, wherein the solid rubber contains at least one member selected from the group consisting of a carboxyl-modified acrylonitrile-butadiene rubber, a hydrogenated acrylonitrile-butadiene rubber and a hydrogenated carboxyl-modified acrylonitrile-butadiene rubber.

14. The golf club grip according to claim 11, wherein the liquid rubber is a rubber having an unsaturated carbon-carbon bond.

15. The golf club grip according to claim 11, wherein the cured product of the grip rubber composition has a density in a range from 1.05 g/cm³ to 1.10 g/cm³.

16. The golf club grip according to claim 11, wherein the cured product of the grip rubber composition has a hardness in a range from 50 to 60 in Shore A hardness.

17. The golf club grip according to claim 11, wherein the liquid rubber is at least one member selected from the group consisting of a liquid isoprene rubber, a liquid carboxyl-modified isoprene rubber, a liquid farnesene rubber, a liquid farnesene-butadiene copolymer, a liquid styrene-butadiene rubber, and a liquid hydrogenated isoprene rubber.

18. The golf club grip according to claim 11, wherein an amount of the liquid rubber ranges from 5 parts by mass to 35 parts by mass with respect to 100 parts by mass of the solid rubber.

19. The golf club grip according to claim 11, wherein the liquid rubber has a number average molecular weight in a range from 20,000 to 150,000.

20. The golf club grip according to claim 11, wherein the liquid rubber has a glass transition temperature of 0° C. or less.
